(19) United States
(12) Patent Application Publication
(10) Pub. No.: US 2011/0178681 A1
(43) Pub. Date: Jul. 21, 2011

(54) METHOD OF PROTECTING MOTOR-DRIVEN STEERING SYSTEM FROM OVERHEAT

(75) Inventor: Eunkyung GU, Yongin-si (KR)

(73) Assignee: HYUNDAI MOBIS CO., LTD., Seoul (KR)

(21) Appl. No.: 12/947,772

(22) Filed: Nov. 16, 2010

(30) Foreign Application Priority Data
Jan. 20, 2010 (KR) 10-2010-005137

(51) Int. Cl. B62D 6/00

(52) U.S. Cl. 701/42

(57) ABSTRACT

In a method of protecting a motor-driven power steering system from overheat, it is possible to prevent a set temperature value from being largely increased by the peripheral circuits of the electronic control unit and improve safety of the motor-driven power steering system by controlling steering current on the basis of the accurate temperature without the effect by the peripheral circuits, by determining when a temperature value measured by a temperature sensor of an electronic control unit is measured high by the peripheral circuits of the electronic control unit and making the set temperature value close to a previous-set temperature value.

### CROSS-REFERENCE TO RELATED APPLICATIONS

The present application claims priority to Korean Patent Application Number 10-2010-005137, filed Jan. 20, 2010, the entire contents of which application is incorporated herein for all purposes by this reference.

### BACKGROUND

1. Field

The present disclosure relates to a method of protecting a motor-driven power steering system from overheat, in detail, a method of protecting a motor-driven power steering system which can increase safety by preventing changes in temperature due to peripheral circuits.

2. Description of Related Art

In general, MDPS (Motor Driven Power Steering) systems operate a power-steering with a steering motor disposed at the lower end portion of the steering wheel shaft when vehicles are started, without using a common method that operates a power steering by using oil circulated by operating a power pump.

In these motor-driven power steering systems, the output of the steering motor is increased when a large amount of current is continuously supplied to the steering motor, such that a field effect transistor (hereafter, referred to as “FET”) of the steering motor and the electronic control unit controlling the operation of the steering motor could be broken by overheat.

The information disclosed in this Background section is only for enhancement of understanding of the general background of the invention and should not be taken as an acknowledgement or any form of suggestion that this information forms the prior art already known to a person skilled in the art.

### SUMMARY

Various aspects of the present invention are directed to provide a method of protecting a motor-driven power steering system from overheat that can determine when a temperature value measured by a temperature sensor of an electronic control unit is measured high by the peripheral circuits of the electronic control unit, prevent a set temperature value from being largely increased by the peripheral circuits of the electronic control unit by making the set temperature value close to a previous-set temperature value, and improve safety of the motor-driven power steering system by controlling steering current on the basis of the accurate temperature without the effect by the peripheral circuits.

An aspect of the present invention provides a method of protecting a motor-driven power steering system from overheat, which includes: a step of measuring temperature in which a temperature sensor of an electronic control unit measures temperature; a step of determining temperature which determines whether a temperature value, which is the temperature of the electronic control unit measured by the temperature sensor, is larger than a previous-set temperature value stored in the electronic control unit; a step of measuring current in which a current sensor of the electronic control unit measures steering current, which is the current of a steering motor, when the temperature value is larger than the previous-set temperature in the step of determining temperature; a step of determining whether the steering current measured by the current sensor flows; and a step of first filtering in which the electronic control unit outputs a temperature value obtained by adding a first filtering value to the previous-set temperature, when it is determined that current flows in the step of determining current.

When it is determined that the steering current does not flow in the step of determining current, a step of second filtering may be performed in which a set temperature value added with a second filtering value is outputted to make the set temperature value outputted by the electronic control unit close to the previous-set temperature.

The second filtering value may be smaller than the first filtering value.

The second filtering value may be computed using a second correction coefficient of about 0.15° C./minute.

When the temperature value is less than the previous-set temperature in the step of determining temperature, the electronic control unit may perform a step of third filtering to output a set temperature value obtained by subtracting a third filtering value from the previous-set temperature value.

The third filtering value may be computed using a second correction coefficient of about 20° C./minute.

When the outputted set temperature value is larger than critical temperature, the electronic control unit may perform a step of controlling steering motor current which limit current supplied to the steering motor.

The first filtering value may be computed using a second correction coefficient of about 30° C./minute.

A method of protecting a motor-driven power steering system from overheat includes determining when a temperature value measured by a temperature sensor of an electronic control unit is measured high by the peripheral circuits of the electronic control unit and makes the set temperature value close to a previous-set temperature value. Thus, it is possible to prevent a set temperature value from being meaninglessly increased by the peripheral circuits of the electronic control unit in the system and improve safety of the motor-driven power steering system by controlling steering current on the basis of the accurate temperature without the effect by the peripheral circuits.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 is a flowchart illustrating a method of protecting a motor-driven power steering system from overheat according to an embodiment of the present invention.

FIG. 2 is a block diagram illustrating a motor-driven power steering system in accordance with an embodiment of the present invention.

### DETAILED DESCRIPTION OF EMBODIMENTS

Reference will now be made in detail to various embodiments of the present invention(s), examples of which are illustrated in the accompanying drawings and described below. While the invention(s) will be described in conjunction with embodiments, it will be understood that present description is not intended to limit the invention(s) to those embodiments. On the contrary, the invention(s) is/are intended to cover not only the embodiments, but also various alternatives, modifications, equivalents and other embodiments, which may be included within the spirit and scope of the invention as defined by the appended claims.

In an example, the motor-driven power steering systems estimate the temperature of the steering motor and the FET of the electronic controller by monitoring the temperature measured by a temperature sensor mounted in the electronic controller and the current applied to the steering motor, and control the current that is applied to the steering motor on the basis of the estimated results.

The temperature of the electronic control unit measured by the temperature sensor in the electronic control unit, however, is measured higher than the actual temperature of the electronic control unit under the influence of the peripheral circuits of the electronic control unit. That is, since the temperature measured by the temperature sensor is higher than the actual temperature, it is difficult to estimate the accurate internal temperature of the electronic control unit. Accordingly, when an error occurs in estimating the temperature that is a reference for controlling the current supplied to the steering motor, as described above, it is hard to stably control the motor-driven power steering system.

Embodiments of the present invention are described in detail as follows such that those skilled in the art can easily implement the present invention.

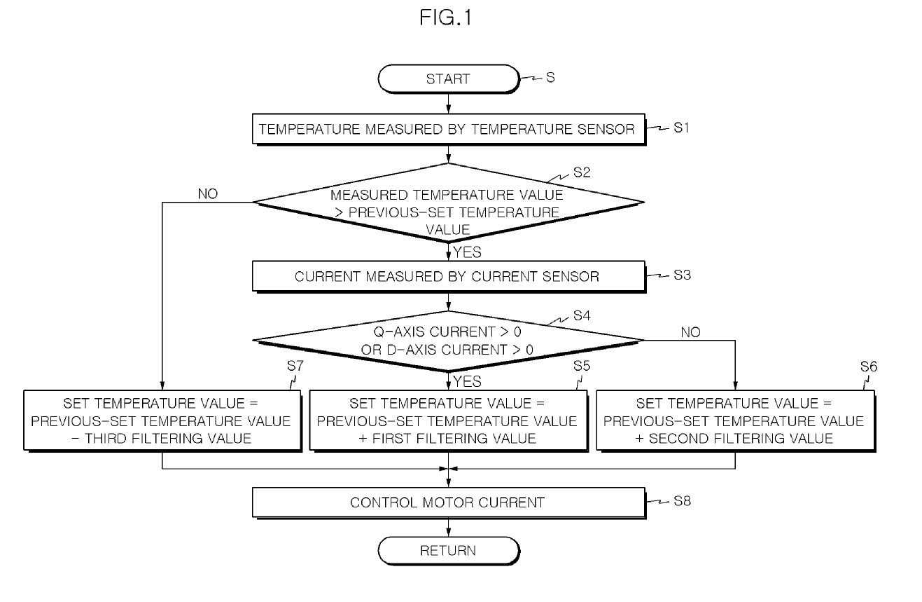

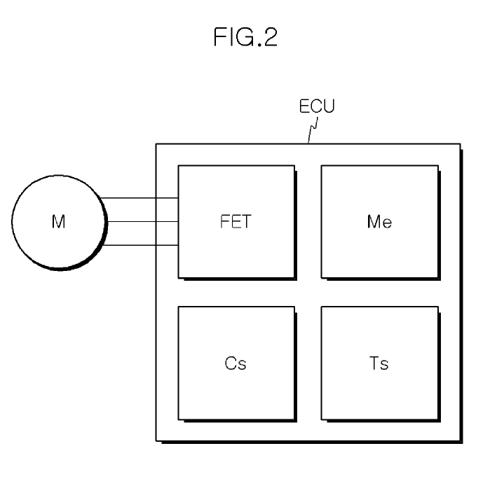

FIG. 1 is a flowchart illustrating a method of protecting a motor-driven power steering system from overheat, according to an embodiment of the present invention. FIG. 2 is a block diagram illustrating a motor-driven power steering system.

A motor-driven power steering system 10 includes an electronic control unit ECU and a steering motor M. Steering motor M is driven by the torque generated when the driver turns the steering wheel. Driving steering motor M is controlled by switching a plurality of field effect transistors FET, which is driving elements of electronic control unit.

The field effect transistors FET control the operation of steering motor M by applying or cutting voltage to each coil of steering motor M in response to signals supplied from the ECU.

A temperature sensor Ts provided in electronic control unit ECU measures the temperature value, which is the temperature of electronic control unit ECU.

Electronic control unit ECU determines whether the measured temperature value is larger than the previous-set temperature value stored in a memory Me. Electronic control unit ECU outputs a set temperature value obtained by filtering or processing the previous-set temperature value, when the measured temperature value is smaller than the previous-set temperature value stored in memory Me.

Further, a current sensor Cs provided in electronic control unit ECU measures steering current that is the current of steering motor M. Electronic control unit ECU calculates Q-axis current and D-axis current by converting the steering current measured by current sensor Cs to have a biphase. Electronic control unit ECU outputs a set temperature value filtered or estimated from the previous-set temperature value based on the Q-axis current and the D-axis current.

The previous-set temperature value is set temperature value outputted when electronic control unit ECU performs previous filtering or estimating, which is stored in memory Me. Further, electronic control unit ECU outputs the set temperature value, memory Me performs reset to delete the stored previous-set temperature and store new calculated set temperature value.

In order to perform the method of protecting motor-driven power steering system 10 from overheat, when the engine starts and power is supplied to electronic control unit ECU (S), temperature sensor Ts of electronic control unit ECU performs a step of measuring temperature in which it measures a temperature value that is the temperature of electronic control unit ECU (S1).

Electronic control unit ECU performs a step of determining temperature to determine whether the temperature value measured by temperature sensor Ts is larger than the previous-set temperature value stored in memory Me of electronic control unit ECU (S2). That is, it is determined in the step of determining temperature (S2) whether the temperature measured by temperature sensor Ts of electronic control unit ECU increased.

Further, when the temperature value measured in the step of determining temperature (S2) is less than the previous-set temperature value, electronic control unit ECU perform a step of third filtering or estimating (S7) to output set temperature value obtained by subtracting a third filtering value or correction value from the previous-set temperature value. That is, when the temperature value measured in the step of determining temperature (S2) is less than the previous-set temperature value, electronic control unit ECU outputs a set temperature value, which is lower than the previous-set temperature value, by subtracting the third filtering value from the previous-set temperature value, in order to stabilize motor-driven power steering system 10. In some embodiments, the third filtering value has a relationship with a change in temperature to time and depends on characteristics of temperature sensor Ts. In one embodiment, the third filtering value is computed using a third correction coefficient of about 20° C./minute.

Further, when the temperature value measured in the step of determining temperature (S2) is larger than the previous-set temperature value, a step of measuring current (S3) is performed in which temperature sensor Ts of electronic control unit ECU measures steering current that is current of steering motor M. Electronic control unit ECU converts the 3-phase current, which is the steering current of steering motor M, into the current of the Q-axis, which is a fixed coordinate axis, and the current of the D-axis to have biphase. That is, electronic control unit ECU the 3-phase steering current into the Q-axis current and the D-axis current.

Further, electronic control unit ECU performs a step of determining current (S4) to determine whether at least one of the Q-axis current and the D-axis current is larger than 0 in order to determine whether the steering current is outputted. That is, electronic control unit ECU determines that the steering current is outputted, when the Q-axis current is larger than 0 or the D-axis current is larger than 0, or the Q-axis current and the D-axis current are both larger than 0 in the step of determining current (S4).

When at least one of the Q-axis current and the D-axis current is larger than 0 in the step of determining current (S4), electronic control unit ECU performs a step of first filtering (S5) to output a set temperature value obtained by addition the first filtering value or correction value to the previous-set temperature value.

That is, when it is determined that the steering current is outputted in the step of determining current (S4), the temperature of electronic control unit ECU has been increased by the steering current, such that electronic control unit ECU outputs a set temperature value larger than the previous-set temperature value by adding the first filtering value to the previous-set temperature value.

In some embodiments, the first filtering value has a relationship with a change in temperature to time and depends on characteristics of temperature sensor Ts. In one embodiment, the first filtering value is computed using a first correction coefficient of about 30° C./minute.

When the Q-axis current and the D-axis current are both 0 in the step of determining current (S4), electronic control unit ECU performs a step of second filtering (S6) to output a set temperature value obtained by addition the second filtering value or correction value to the previous-set temperature value.

That is, when it is determined in the step of determining current (S4) that the steering current was not outputted, it is determined that the temperature of electronic control unit ECU was increased by not the steering current, but the peripheral circuits around electronic control unit ECU. Therefore, electronic current ECU maintains the set temperature value at the previous-set temperature value, preventing it from being changed by the temperature value measured by temperature sensor Ts. Electronic control unit ECU outputs set temperature value by adding the small second filtering value, which is smaller than the first filtering value, to the previous-set temperature value to reflect a portion of the increase in temperature.

In some embodiments, the second filtering value has a relationship with a change in temperature to time and set on the basis of experiment data of changes in temperature of motor-driven power steering system 10. In one embodiment, the second filtering value is computed using a second correction coefficient of about 0.15° C./minute. That is, in the step of second filtering (S6), it is possible to prevent an error causing the temperature of electronic control unit ECU to be measured high by the peripheral circuits, by keeping the set temperature value without a large difference from the previous-set temperature value, in comparison with the step of first filtering (S5).

Further, when the set temperature value is set in one of the step of first filtering (S5), the step of second filtering (S6), and the step of third filtering (S3), and the set temperature value is larger than the critical temperature stored in electronic control unit ECU, a step of controlling motor current (S8) controlling the current supplied to steering motor M by limiting the current supplied to the steering motor is performed.

The method of protecting a motor-driven power steering system from overheat can prevent an error that the set temperature value is increased by the peripheral circuits of electronic control unit ECU, by determining when the temperature value measured by temperature sensor Ts of electronic control unit ECU is measured high by the peripheral circuits of electronic control unit ECU and maintaining the set temperature value at the previous-set temperature value. Therefore, the method of protecting a motor-driven power steering system from overheat can accurately estimate a set temperature value that is the temperature of electronic control unit ECU by determining that the temperature of electronic control unit ECU is increased by the peripheral circuits, and control the steering current, such that it is possible to improve safety of motor-driven power steering system 10.

The foregoing descriptions of specific embodiments of the present invention have been presented for purposes of illustration and description. They are not intended to be exhaustive or to limit the invention to the precise forms disclosed, and obviously many modifications and variations are possible in light of the above teachings. The embodiments were chosen and described in order to explain certain principles of the invention and their practical application, to thereby enable others skilled in the art to make and utilize various embodiments of the present invention, as well as various alternatives and modifications thereof. It is intended that the scope of the invention be defined by the Claims appended hereto and their equivalents.

What is claimed is:

1. A method of protecting a motor-driven power steering system from overheat, the method comprising:
measuring a temperature at a position using a temperature sensor located in a motor-driven power steering system;
providing a first temperature value which represents a temperature of the motor-driven power steering system at a particular time prior to measuring;
determining whether the measured temperature is greater than the first temperature value;
if determined that the measured temperature is greater than the first temperature value, obtaining an electric current value which represents electric current of a steering motor of the motor-driven steering system;
determining whether the electric current value is greater than a predetermined amount;
if determined that the electric current value is greater than a predetermined amount, estimating a second temperature value representing a temperature of the motor-driven power steering system at a current time by adding a first correction value to the first temperature value; and
controlling an electric power supplied to the steering motor based on the second temperature value.

2. The method of claim 1, wherein controlling comprises limiting the electric power to the steering motor when the second temperature value is greater than a predetermined value.

3. The method of claim 1, further comprising:
if determined that the electric current value is equal to or smaller than a predetermined amount, estimating the second temperature value by adding a second correction value to the first temperature value, wherein the second correction value is smaller than the first correction value.

4. The method of claim 3, wherein the first correction value is computed by multiplying a first correction coefficient with a time period between the particular time and the current time, wherein the first correction coefficient ranges from about 25° C./minute to about 35° C./minute.

5. The method of claim 3, wherein the second correction value is computed by multiplying a second correction coefficient with a time period between the particular time and the current time, wherein the second correction coefficient ranges from about 0.1° C./minute to about 5° C./minute.

6. The method of claim 1, further comprising, if determined that the measured temperature is smaller than the first temperature value, estimating the second temperature value by subtracting a third correction value from the first temperature value.

7. The method of claim 6, wherein the third correction value is computed by multiplying a third correction coefficient with a time period between the particular time and the current time, wherein the third correction coefficient ranges from about 15° C./minute to about 25° C./minute.

8. The method of claim 1, wherein the electric current value is one of the q-axis current or d-axis current obtained from the electric current of the steering motor.

9. A motor-driven power steering system comprises an electric motor and a control circuit which comprises a temperature sensor and configured to control the electric motor, wherein the control circuit is further configured to perform the method of claim 1.

10. A vehicle comprising the motor-driven power steering system of claim 9.

11. A method of protecting a motor-driven power steering system from overheat, the method comprising:
measuring temperature in which a temperature sensor of an electronic control unit measures temperature;
determining temperature which determines whether a temperature value, which is the temperature of the electronic control unit measured by the temperature sensor, is larger than a previous-set temperature value stored in the electronic control unit;
measuring current in which a current sensor of the electronic control unit measures steering current, which is the current of a steering motor, when the temperature value is larger than the previous-set temperature;
determining whether the steering current measured by the current sensor flows; and
filtering in which the electronic control unit outputs a set temperature value obtained by adding a first filtering value to the previous-set temperature, when it is determined that current flows.

12. The method of protecting a motor-driven power steering system as defined in claim 11, wherein when it is determined that the steering current does not flow, a step of second filtering is performed in which a set temperature value added with a second filtering value is outputted to make the set temperature value outputted by the electronic control unit close to the previous-set temperature.

13. The method of protecting a motor-driven power steering system as defined in claim 12, wherein the second filtering value is smaller than the first filtering value.

14. The method of protecting a motor-driven power steering system as defined in claim 12, wherein the second filtering value is computed using a second correction coefficient of about 0.15° C./minute.

15. The method of protecting a motor-driven power steering system as defined in claim 11, wherein when the temperature value is less than the previous-set temperature, the electronic control unit performs a step of third filtering to output a set temperature value obtained by subtracting a third filtering value from the previous-set temperature value.

16. The method of protecting a motor-driven power steering system as defined in claim 15, wherein the third filtering value is computed using a second correction coefficient of about 20° C./minute.

17. The method of protecting a motor-driven power steering system as defined in claim 11, wherein the electronic control unit performs a step of controlling steering motor current which limits current supplied to the steering motor, when the outputted set temperature value is larger than critical temperature.

18. The method of protecting a motor-driven power steering system as defined in claim 11, wherein the first filtering value is computed using a first correction coefficient of about 30° C./minute.

19. A motor-driven power steering system comprising the electric control unit configured to perform the method of claim 11.
